(19) United States
(12) Patent Application Publication
(10) Pub. No.: US 2015/0087170 A1
(43) Pub. Date: Mar. 26, 2015

(54) ELECTRIC CONNECTOR FOR SHIELDING HIGH VOLTAGE

(71) Applicant: Hyundai Motor Company, Seoul (KR)

(72) Inventors: Mun Jong Kim, Siheung (KR); Jeong Han Kim, Hwaseong (KR)

(73) Assignee: HYUNDAI MOTOR COMPANY, Seoul (KR)

(21) Appl. No.: 14/109,063

(22) Filed: Dec. 17, 2013

(30) Foreign Application Priority Data
Sep. 23, 2013 (KR) 10-2013-0112599

(51) Int. Cl. H01R 13/6597

(52) U.S. Cl. CPC H01R 13/6597
USPC 439/108

(57) ABSTRACT

A shielding device that shields high voltage for a voltage connector is provided. In the shielding device, a second wire is brought into contact with a first wire and a shielding terminal is formed at the end of the second wire to shield contact between a voltage connector and the first wire. The shielding terminal is then connected to a shielding plate in the voltage connector to ground the shielding terminal.

### CROSS-REFERENCE TO RELATED APPLICATION

This application claims under 35 U.S.C, §119(a) the benefit of Korean Patent Application No. 10-2013-0112599 filed Sep. 23, 2013, the entire contents of which are incorporated herein by reference,

### BACKGROUND

(a) Technical Field

The present disclosure relates to an electric connector for shielding high voltage, and more particularly, to a shielding device for a high-voltage connector that connects a high-voltage connector and a high-voltage wire while shielding electric noise,

(b) Background Art

Eco-friendly vehicles such as an electric vehicle and a hybrid vehicle are equipped with many electric parts such as an inverter and a motor, including a high-voltage battery, and the parts are electrically connected with high-voltage connectors and high-voltage wires. Since high-voltage current flows through the high-voltage connectors and the high-voltage wires, a specific electric shielding structure is required, and particularly the joint between the high-voltage connectors and the high-voltage wires requires an electric shielding. When the joint of the high-voltage connector and the high-voltage wire does not include a shield, an electric noise such as, electric waves leaks to the exterior and may cause malfunction or damage in the peripheral electric and electronic parts.

Accordingly, a shielding structure is used at the joint between high-voltage connectors and high-voltage wires. An electric shielding device of the related art which is used for those high-voltage connectors and high-voltage wires are described with reference to FIGS. 1A-1B and 2.

In FIGS. 1A and 1B, the reference numeral ‘10’ indicates a high-voltage connector and the reference numeral ‘20’ indicates a high-voltage wire. The coating layer at the front end portion of the high-voltage wire 20 is removed for electric connection of the high-voltage connector 10 with a main terminal 12 and a conducting wire 22 within the high-voltage wire is exposed. The conducting wire 22 exposed by removing the front coating layer of the high-voltage wire 20 is electrically connected with the main terminal 12 disposed within the connector 10. The conducting wire 22 of the high-voltage wire 20 is exposed to the exterior, while connected with the main terminal 12 in the high-voltage connector 10, thus requiring to be electrically shielded.

Accordingly, the shielding mechanism fastened to the conducting wire 22 of the high-voltage wire 20 includes a conductive clamp ring 24 a clamp shield 26 that are in close contact to cover the wire 22, and a waterproof seal 28 that prevents water from entering the high-voltage wire 20 and the waterproof seal 28 is fastened in close contact with the rear of the clamp shield 26.

Further, the shielding mechanism for the high-voltage connector 10 includes a shielding plate 14 attached to the inner side of a case 12 of the high-voltage connector, a rear holder 16 disposed at the rear portion of the case 12 with the high-voltage wire 20 passing there through, and a shielding-connecting plate 18 coupled to the rear holder 16 and conductively connecting the clamp shield 26 and the shielding plate 14.

Accordingly, even when a noise such as electronic waves is generated with a high voltage applied to the high-voltage wire 20 and a high-voltage current flowing through the wire, the voltage is grounded through the clamp shield 26 coupled to the conducting wire 22 of the high-voltage wire 20, the shielding-connecting plate 18 coupled to the rear holder 16, and the shielding plate 14 in the high-voltage connector 10, such that it may be possible to prevent influence of the electric noise on the peripheral electric, and electronic parts.

However, in the shielding device of the related art, various parts such as the rear holder and the shielding-connecting plate, including the clamp ring and the clamp shield coupled to the high-voltage wire and the shielding plate of the high-voltage connector, are arranged in a complex manner and the efficiency of assembly and production is considerably decreased. Further, the entire size, the weight, and the manufacturing cost of the high-voltage connector increases.

The above information disclosed in this section is only for enhancement of understanding of the background of the invention and therefore it may contain information that does not form the prior art that is already known in this country to a person of ordinary skill in the art.

### SUMMARY

The present invention provides a shielding device for a high-voltage connector having a structure that simplifies the assembly structure and the parts, in comparison to the related art, by bringing a common wire in close contact with a high-voltage wire and forming a shielding terminal at the end of the common wire, to shield contact between a high-voltage connector and the high-voltage wire, and by connecting the shielding terminal to a shielding plate in the high-voltage connector to ground the terminal.

In particular, the present invention provides a shielding device for a high-voltage connector that may include: a shielding-leading wire disposed on a high-voltage wire; and a normal wire with one end conductively connected to the shielding-leading wire of the high-voltage wire and the other end connected with a shielding terminal, in which when the conducting wire of the high-voltage wire is conductively connected with the main terminal in the high-voltage connector, the shielding terminal of the normal wire may be connected to a shielding plate on the inner wall of the high-voltage connector to ground the shielding terminal.

Further, the shielding-leading wire of the high-voltage wire may be formed by twisting one of a plurality of conducting wires in the coating layer of the high-voltage wire to the surface of the coating layer. In addition, the shielding-leading wire of the high-voltage wire and one end of the normal wire may come into contact with each other (e.g., may connect, etc.) under pressure and a thermal contractive tube made of an insulating material may be attached to the contact portion to cover the portion. The surface, except for the front end portion, of the entire surface of the shielding terminal of the normal wire may be coated with a housing made of an insulating material. A position-fixing holder that maintains alignment with the main terminal may be fitted on the portion connected with the main terminal of the high-voltage wire.

According to the present invention, it may be possible to prevent influence due to electric noise between peripheral electric and electronic parts, with a simplified shielding configuration that connects a normal wire (e.g., common wire, a non-shielding wire) with a conducting wire of a high-voltage wire under pressure, forming a shielding terminal at the end of the normal wire, and then connecting the shielding terminal to a shielding plate in a high-voltage connector to ground the shielding terminal, as described above.

In particular, since the parts used for the shielding device of the present invention are the normal wire and the shielding terminal, it may be possible to reduce the number of parts in comparison to the number of parts in the shielding device of the related art (e.g., eliminating clamp ring and clamp shield, and shielding plate, rear holder, and shielding-connecting plate of the high-voltage connector). Therefore, it may be possible to improve the efficiency of assembly and production, in addition to reducing the manufacturing cost. Further, according to the shielding device of the present invention, it may be possible to reduce the entire size and weight of a high-voltage connector.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIGS. 1A-1B and 2 are exemplary views showing a shielding device for a high-voltage connector of the related art;

FIG. 3 is an exemplary view showing a process of assembling a shielding device for a high-voltage connector according to an exemplary embodiment of the present invention;

FIG. 4 is an exemplary cross-sectional view showing the shielding device for a high-voltage connector according to an exemplary embodiment of the present invention after assembled; and

FIG. 5 is an exemplary view comparing the shielding device of the present invention and the shielding device of the related art according to an exemplary embodiment of the present invention.

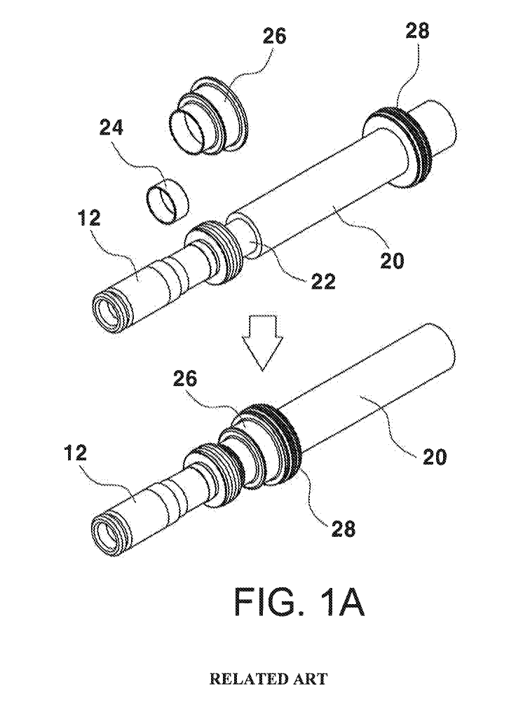

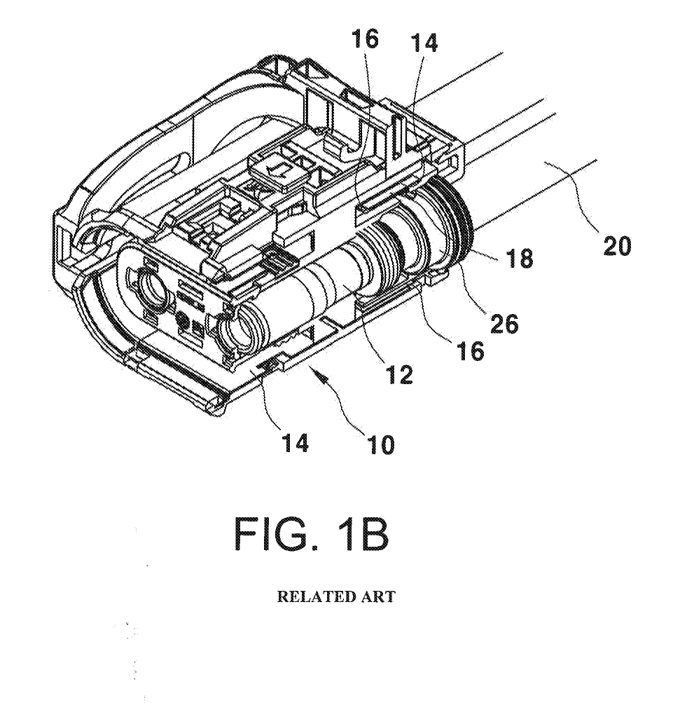

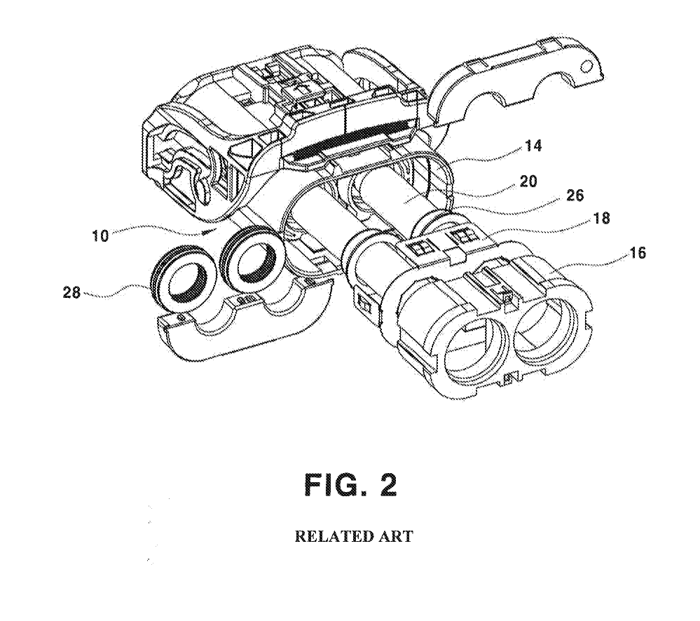

| | |
|---|---|
| 10: high-voltage connector | 12: main terminal |
| 14: shielding plate | 16: rear holder |
| 18: shielding-connecting plate | 20: high-voltage wire (e.g., a first wire) |
| 22: conducting wire | 24: clamp ring |
| 26: clamp shield | 28: waterproof seal |

30: shielding-leading wire
40: normal wire (e.g., a second wire)

| | |
|---|---|
| 42: shielding terminal | 44: thermal contractive tube |
| 46: housing | 48: position-fixing holder |

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, exemplary embodiments of the present invention are described in detail with reference to the accompanying drawings. Referring to FIGS, 3 and 4, a coating layer at the front end portion of a high-voltage wire 20 may be removed for electric connection of a high-voltage connector 10 with a main terminal 12 and a conducting wire 22 inside the high-voltage wire 20 may be exposed.

The conducting wire 22 of the high-voltage wire 20 (e.g., a first wire) may be exposed to the exterior and noise such as electronic waves may be generated, while connected to the main terminal 12 in the high-voltage connector 10, thus requiring the high-voltage wire 20 to be electrically shielded. Accordingly, a shielding-leading wire 30 may be disposed on the high-voltage wire 20.

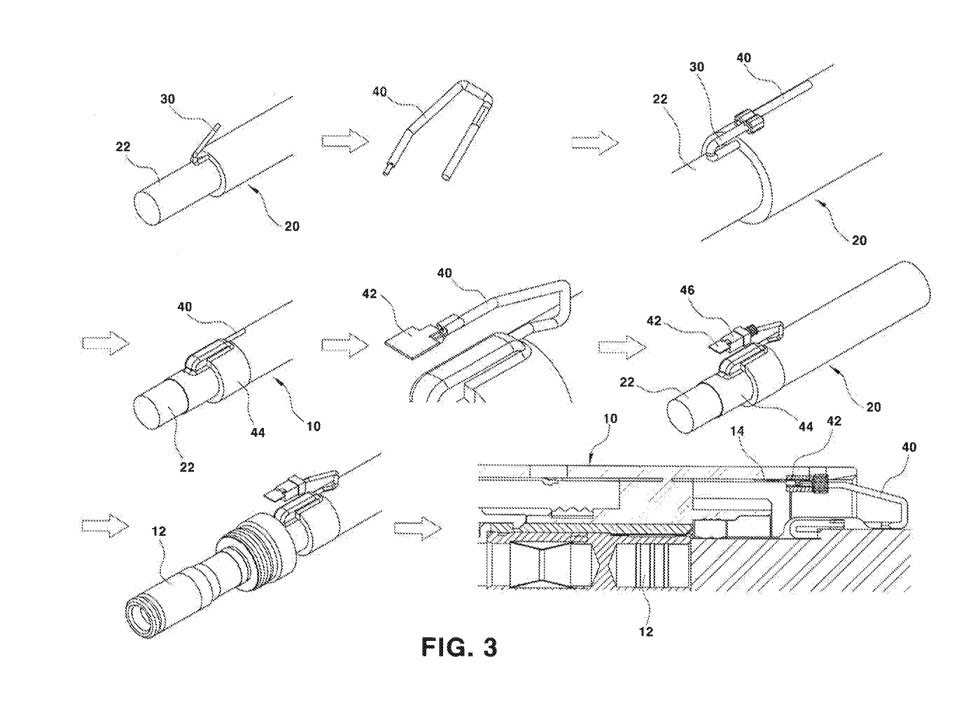

The shielding-leading wire 30, as shown in FIG. 3, may be formed by twisting one braid of a plurality of conducting wires 22 in the coating layer of the high-voltage wire 20 (e.g., the first wire) to the surface of the coating layer, for shielding. A common wire, that is, a normal wire 40 (e.g., a second wire) may be conductively connected to the shielding-leading wire 30. Further, one end (e.g., the portion with the coating layer removed) of the normal wire 40 may be jointed to the shielding-leading wire 30 and pressed to be one unit. A thermal contractive tube 44 made of an insulating material may be attached to the portion where the shielding-leading wire 30 of the high-voltage wire 20 and the end of the normal wire 40 are in contact under pressure, to cover the portion. The thermal contractive tube 44, which may be made of a polymer that contracts by heat that is generated when high-voltage current flows, may hermetically cover the joint between the shielding-leading wire 30 and the normal wire 40 (e.g., the second wire) while contracting by heat, and may operate as a shield to prevent the inflow of water.

Furthermore, as shown in FIG. 3, a shielding terminal 42 may be connected to the other end (e.g., the portion with the coating layer removed) of the normal wire 40 and the shielding terminal 42 may be coated with a housing 46 made of an insulating material. The housing 46 may be coated to insulate and protect the surface of the shielding terminal 42 and may operate as a support when the shielding terminal 42 is coupled to the shielding plate 14 in the high-voltage connector 10. In particular, the housing 46 may be coated on the surface, except for the front end portion (e.g., the portion being in contact with the shielding plate 14 to be grounded) of the entire surface of the shielding terminal 42 of the normal wire 40. The conducting wire 22 of the high-voltage 20 may be conductively connected with the main terminal 12 in the high-voltage connector 10.

Finally, when the conducting wire 22 of the high-voltage wire 20 is conductively connected with the main terminal 12 in the high-voltage connector 10, the shielding terminal 42 of the normal wire 40 may be connected to the shielding plate 14 on the inner side of the high-voltage connector 10 to ground the shielding terminal 42. Accordingly, even when noise such as electronic waves is generated with a high voltage applied to the high-voltage wire 20 and a high-voltage current flowing through the high-voltage wire 20, the voltage may he grounded through the shielding plate 14 in the high-voltage connector 10 through the shielding terminal 42 of the normal wire 40 connected with the shielding-conducting wire 30 of the high-voltage wire 20, to prevent influence of the electric noise on the peripheral electric and electronic parts.

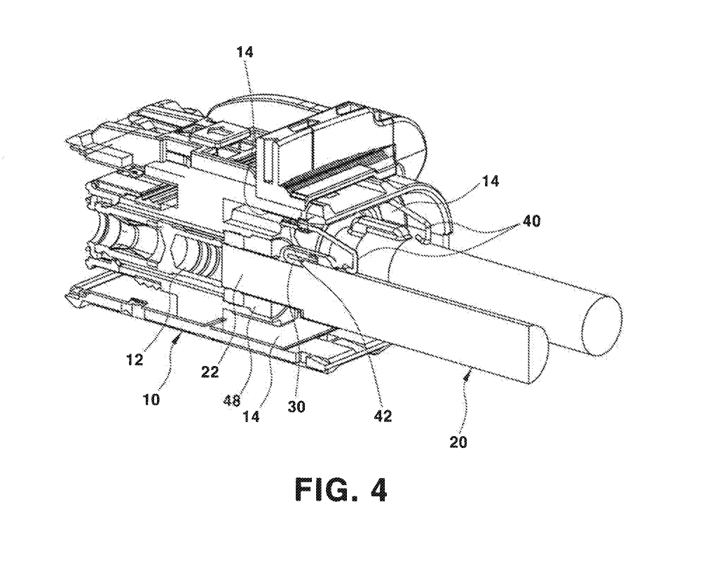

Moreover, a position-fixing holder 48 may be fitted on the conducting wire 22 of the high-voltage wire 20, that is, the portion connected with the main terminal 12 in the high-voltage connector 10 and covered with the thermal contractive tube 44. When the position-fixing holder 48 is inserted with the high-voltage wire 20 into the high-voltage connector 10, as shown in FIG. 4, the outer circumferential portion of the position-fixing holder 48 may come into contact with the inner side of the high-voltage connector 10, causing the position-fixing holder 48 to fix and maintain the high-voltage wire 20 aligned with the main terminal 12.

It may be possible to prevent influence due to electric noise between peripheral electric and electronic parts, with a simplified shielding configuration of connecting a normal wire to the conducting wire of a high-voltage wire, forming a shielding terminal on the normal wire, and then connecting the shielding terminal to a shielding plate in a high-voltage connector to ground the shielding terminal, as described above.

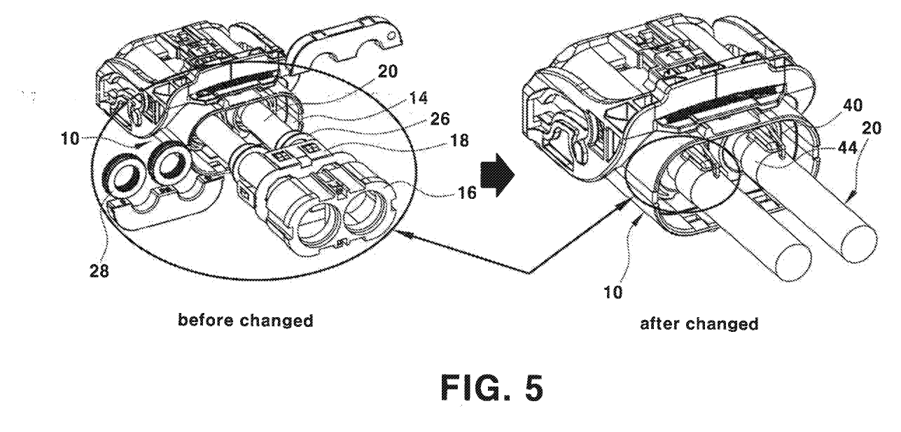

In particular, as seen from the comparing view of FIG. 5, since the parts used in the shielding device of the present invention are the normal wire 40 and the shielding terminal 42, it may be possible to considerably reduce the number of parts in comparison to the number of parts in the shielding device of the related art (e.g., damp ring 24 and clamp shield 26, and shielding plate, rear holder 16, and shielding-connecting plate 18 of the high-voltage connector may be eliminated) and to reduce the manufacturing cost. Further, it may be possible to reduce the entire size and weight of a high-voltage connector.

The invention has been described in detail with reference to exemplary embodiments thereof. However, it will be appreciated by those skilled in the art that changes may be made in these embodiments without departing from the principles and spirit of the invention, the scope of which is defined in the accompanying claims and their equivalents.

What is claimed is:

1. A shielding device for a voltage connector, comprising:
a shielding-leading wire disposed on a first wire;
a second wire with one end conductively connected to the shielding-leading wire of the first wire; and
a shielding terminal coupled to the other end of the second wire,
wherein, when the conducting wire of the first wire is conductively connected with a main terminal the voltage connector, the shielding terminal of the second wire is connected to a shielding plate on an inner wall of the voltage connector to ground the shielding terminal.

2. The device of claim 1, wherein the shielding-leading wire of the first wire is formed by twisting one of a plurality of conducting wires in a coating layer of the first wire to a surface of the coating layer.

3. The device of claim 1, wherein the shielding-leading wire of the first wire and one end of the second wire are connected under pressure and a thermal contractive tube made of an insulating material is attached to a contact portion of the shielding-leading wire of the first wire and one end of the second wire to cover the contact portion.

4. The device of claim 1, wherein the surface, except for a front end portion, of the shielding terminal of the second wire is coated with a housing made of an insulating material.

5. The device of claim 1, wherein a position-fixing holder that maintains alignment with the main terminal is fitted on a portion connected with the main terminal of the first wire.
